(19) United States
(12) Patent Application Publication
(10) Pub. No.: US 2022/0248648 A1
(43) Pub. Date: Aug. 11, 2022

(54) SYSTEM INCLUDING A SELF-POWERED, LIGHT BASED, BYCATCH REDUCTION DEVICE

(71) Applicants: Mark Bailly, Tempe, AZ (US); Jesse Senko, Tempe, AZ (US); Jennifer Blain Christen, Tempe, AZ (US); Michael Goryll, Tempe, AZ (US); Stuart Bowden, Tempe, AZ (US); Christopher Lue Sang, Tempe, AZ (US)

(72) Inventors: Mark Bailly, Tempe, AZ (US); Jesse Senko, Tempe, AZ (US); Jennifer Blain Christen, Tempe, AZ (US); Michael Goryll, Tempe, AZ (US); Stuart Bowden, Tempe, AZ (US); Christopher Lue Sang, Tempe, AZ (US)

(21) Appl. No.: 17/625,677

(22) PCT Filed: Jul. 9, 2020
(86) PCT No.: PCT/US2020/041419

§ 371 Date: Jan. 7, 2022

Related U.S. Application Data
(60) Provisional application No. 62/871,938, filed on Jul. 9, 2019.

(51) Int. Cl. A01K 75/02; A01M 29/10

(52) U.S. Cl. CPC A01K 75/02; A01M 29/10

(57) ABSTRACT

A fisheries bycatch reduction device is disclosed which may be coupled to or positioned proximate to a net. The device includes a housing and an electrical assembly positioned within the housing. The bycatch reduction device uses a power management strategy to control illumination and charging to create a hassle free, readily deployable substitute for traditional buoys and reduces the unintended catch of non-desired marine life.

### CROSS REFERENCE TO RELATED APPLICATIONS

The present document is a PCT patent application that claims benefit to U.S. provisional patent application Ser. No. 62/871,938 filed on Jul. 9, 2019, which is herein incorporated by reference in its entirety.

### FIELD

The present disclosure generally relates to devices for marine-biology applications; and in particular, relates to a lighted fisheries bycatch reduction device.

### BACKGROUND

Small scale fisheries cumulatively account for approximately half of the world's fishing production. These coastal fisheries commonly use a type of entanglement net (i.e. “gillnet”) that is low-cost, high-yield, and easy to maintain. Unfortunately, entanglement-based nets account for a large number of non-target species (bycatch) mortality and can lead to negative impacts on the local ecology. As fishing is a crucial aspect of coastline socioeconomic well-being, it is important to mitigate the circumstances of bycatch, while maintaining a cost-effective solution for these small fisheries. Studies have shown a viable means of reducing bycatch is to introduce net illumination.

It is with these observations in mind, among others, that various aspects of the present disclosure were conceived and developed.

### BRIEF DESCRIPTION OF THE DRAWINGS

FIG. 1 is a simplified illustration of a possible system for reducing bycatch including a bycatch reduction device.

FIG. 2 is a perspective view of one embodiment of a bycatch reduction device which may be used with the system of FIG. 1.

FIG. 3 is an exploded view of the bycatch reduction device of FIG. 2.

FIG. 4A is a simplified block diagram illustrating possible components and functionality of the electrical assembly of the device described herein.

FIG. 4B is a flow chart illustrating logic associated with the microcontroller state machine in context of the electrical assembly described herein.

FIG. 4C is a flow chart illustrating logic associated with the microcontroller state machine in context of the electrical assembly described herein.

FIG. 5 is a perspective view of an outer tube configuration for one embodiment of a bycatch reduction device with portions illustrated in phantom to illustrate aspects of a chamber which receives the electrical assembly described herein.

FIG. 6A is a side view of the electrical assembly positioned or mounted along a carriage and configured for positioning to within the chamber of the housing of FIG. 2.

FIG. 6B is a side view of the bycatch reduction device illustrating possible configurations of the solar cells along the housing of the device.

FIG. 7A is a side view of the bycatch reduction device with portions of the outer tube shown in phantom to illustrate aspects of the solar cells of the device.

FIG. 7B is a side view of one embodiment of a fully constructed bycatch reduction device.

FIG. 8 is a simplified illustration of one implementation of the bycatch reduction device described herein.

FIG. 9 is a simplified illustration of further aspects related to the implementation of the bycatch reduction device described herein.

FIG. 10 is an illustration of one embodiment of a remote which may be included with the system to update, remotely, light settings of the device described and provide other commands and/or provide feedback.

FIG. 11 is a circuit diagram of a printed circuit board (PCB) with various electrical components which may be utilized for one embodiment of the bycatch reduction device described herein.

FIG. 12 is a simplified block diagram of an exemplary computing device which may be implemented with various systems and embodiments described herein.

Corresponding reference characters indicate corresponding elements among the view of the drawings. The headings used in the figures do not limit the scope of the claims.

### DETAILED DESCRIPTION

Embodiments of a system including a self-charging bycatch reduction device to reduce the incidental catch of non-desired marine life are disclosed. The bycatch reduction device uses a power management strategy to control illumination and charging to create a hassle free, readily deployable substitute for traditional buoys that can (and has been shown to) reduce the impact of small-scale fisheries on the local ecology. This reduction in bycatch benefits fishermen by reducing the threat their nets pose to endangered species, and may serve to protect coastal livelihoods from fishing restrictions imposed to protect these endangered species.

In one aspect, the bycatch reduction device is entirely enclosed and requires no user intervention to operate. In addition, the bycatch reduction device does not need to be charged as it is capable of recharging its own power supply during normal operation. The bycatch reduction device is also capable of operating for long periods of time in sun-free areas by adjusting the discharge rate remotely as required. In another aspect, the bycatch reduction device generates no waste as the device does not require disposable batteries or chemistries to produce light. In a yet another aspect, the bycatch reduction device is capable of being adjusted so that the illumination generated by the device matches the needs of the targeted species, region, and dynamic local environment.

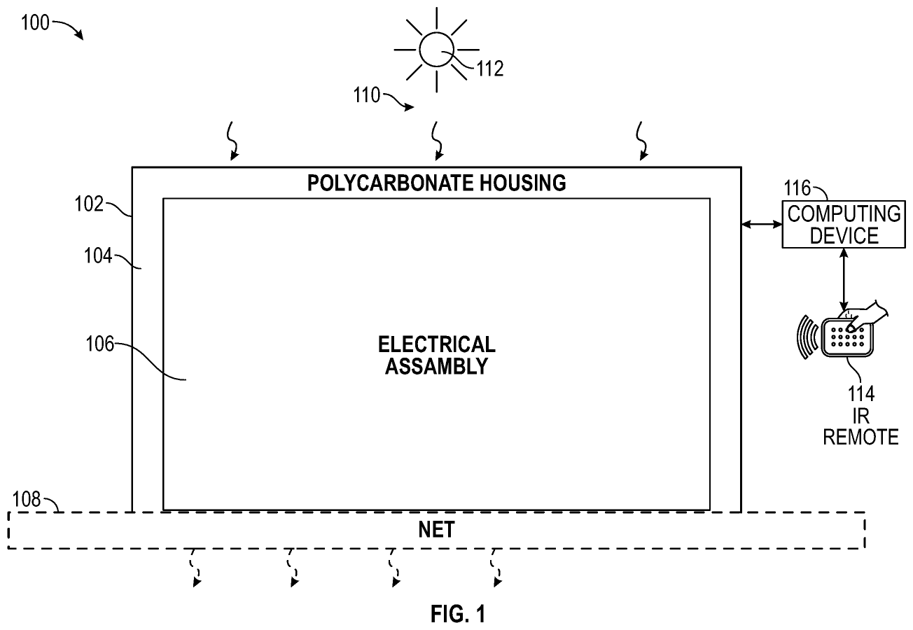

Referring to FIG. 1, one embodiment of a system 100 for reducing bycatch is shown. As indicated, the system 100 includes a bycatch reduction device (“BRT device”) 102, that may generally include a housing 104 and an electrical assembly 106 disposed within the housing 104. In some embodiments, the housing 104 is formed of a polycarbonate material and is at least partially transparent to accommodate illumination of light emitted through the housing as further described herein. In addition, in some embodiments, the BRT device 102 is fixed, tethered, or otherwise mechanically coupled to a net 108. As further described herein, the electrical assembly 106 may include any number of components and features such that the BRT device 102 is self-charging and utilizes solar energy 110 acquired by the sun 112. As further shown, the system 100 may also include embodiments of a remote 114 in operable communication with the BRT device 102, for issuing commands thereto and executing functions of the BRT device 102 as further described herein. In some embodiments, the system 100 may further include a computing device 116 (such as a desktop computer, or mobile device such as a laptop or smartphone) in operable communication with the BRT device 102 and/or the remote 114 via any wired or wireless communication medium or protocol such as Bluetooth, infrared transmission, Wi-Fi, and the like.

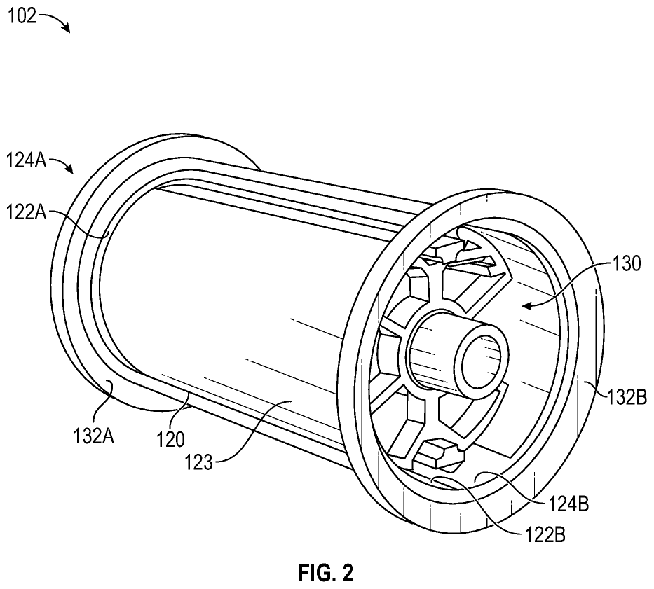

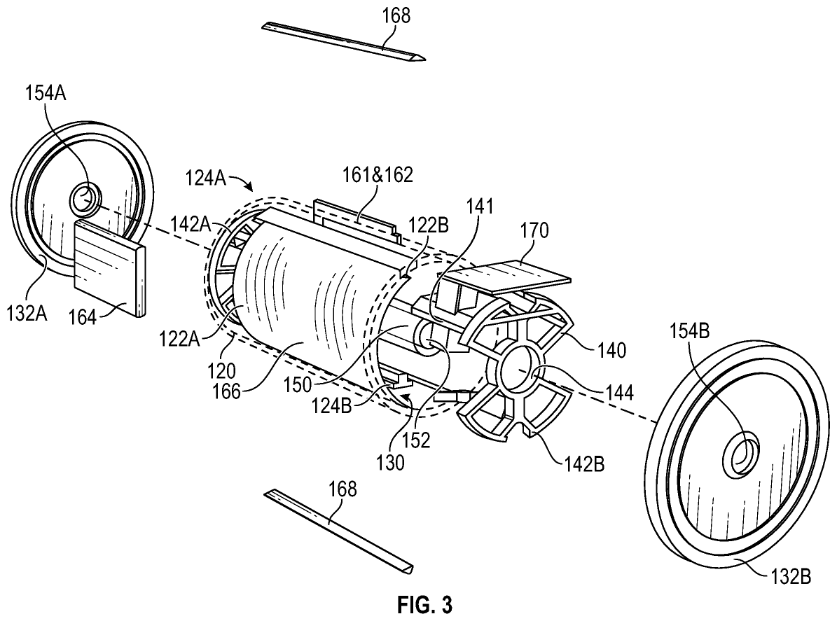

Referring to FIG. 2 and FIG. 3, in some embodiments, the housing 104 of the BRT device 102 includes an outer tube 120 defining a middle portion 123, a first end 122A defined along the middle portion 123, and a second end 122B defined along the middle portion 123 opposite the first end 122A. As further indicated, the outer tube 120 of the housing 104 includes a first opening 124A formed along the first end 122A and a second opening 124B along the second end 122B. In some embodiments, the outer tube 120 is formed with a tubular or cylindrical shape configuration as shown to resemble a buoy and to approximate the size and functionality achieved with the industry standard, but other shape configurations are contemplated. The shape configuration of a buoy is suitable for fishing applications where a lighted buoy device is preferable, and the BRT device 102 can be positioned along or attached to a net like a traditional buoy, such that the device may be seamlessly integrated into existing fishing gear (submerged or afloat) providing a more adoptable device.

As further shown, the outer tube 120 defines a chamber 130 in communication with the first opening 124A and second opening 124B. The chamber 130 receives the electrical assembly 106 such that the electrical assembly 106 is positioned within the chamber 130 substantially between the first end 122A and the second end 122B. Once the electrical assembly 106 is positioned within the chamber 130 as described, a first endcap 132A may be positioned along and mounted to the first end 122A, and a second endcap 132B may be positioned along and mounted to the second end 122B, to enclose the electrical assembly 106 within the chamber 130 of the housing 104. In some embodiments, the first endcap 132A and the second endcap 132B are sealed along the first opening 124A and the second opening 124B respectively to form a permanent waterproof seal protecting the electrical assembly 106 from water, contaminants, and the like. In some embodiments, once the electrical assembly 106 is fully assembled and connected, at least some portions of the electrical assembly 106 (including the carriage 140 of FIG. 3) may be affixed with an adhesive or other any number of securing members (to e.g., maintain the position of the electrical assembly 106 relative to the chamber 130 and to reduce movement within the chamber 130), and then the BRT device 102 may be sealed with a vulcanizing solvent.

FIG. 3 illustrates exemplary components of the electrical assembly 106 and possible arrangement and positioning of these components along the housing 104 of the BRT device 102. At least a portion of the components of the electrical assembly 106 are mounted to or arranged along a carriage 140, which generally defines a linear predefined structure (e.g., a predefined ABS plastic structure) that functions as an electrical mount. The carriage 140 includes a middle portion 141 and a first end 142A and a second end 142B defined along opposite ends of the middle portion 141, such that the first end 142A of the carriage 140 may be substantially aligned within the chamber 130 along the first end 122A of the of the housing 104, and the second end 142B may be substantially aligned along the second end 122B in the manner shown.

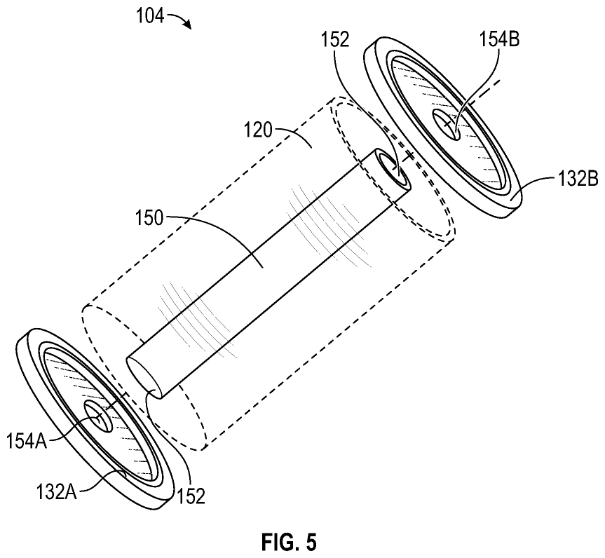

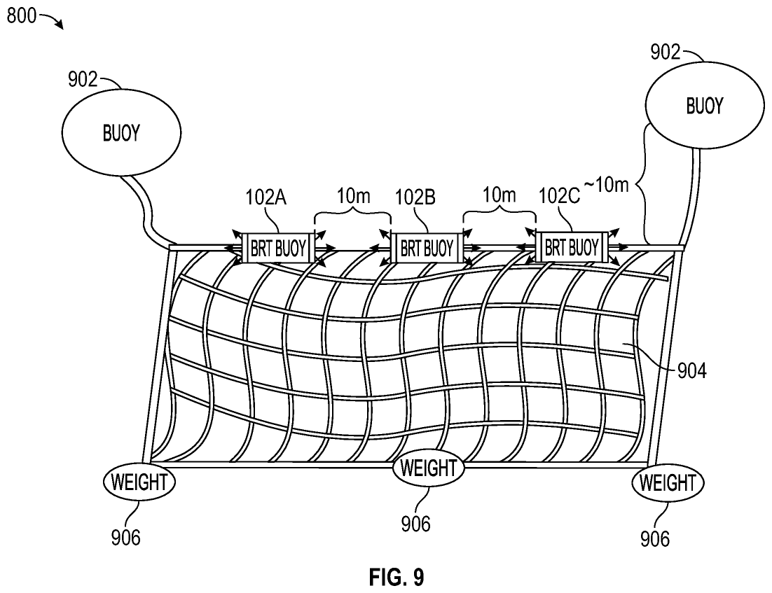

The carriage 140 may include any number of openings, such as opening 144, to accommodate additional features of the BRT device 102. For example, in some embodiments, the housing 104 of the BRT device 102 includes an inner tube 150 (shown more clearly in FIG. 5) that extends linearly within the chamber 130 from the first end 122A of the outer tube 120 to the second end 122B of the outer tube 120. The inner tube 150 defines a channel 152 that accommodates passing of a float-line/rope used to affix the buoy to the net 108, or any other suitable structure (illustrated in FIG. 9). In addition, the inner tube 150 may be received through any of the openings 144 of the carriage 140 to maximize use of space within the chamber 130. In these embodiments, openings 154, designated opening 154A and opening 154B, may be formed respectively along the first endcap 132A and the second endcap 132B and may be in communication with the channel 152 of the inner tube 150 to accommodate passage of a line, rope, or other structure entirely lengthwise through the BRT device 102.

The mechanical structures encompassing the housing 104 and the carriage 140 may be comprised of any number of different materials or combinations thereof. In some embodiments, the housing 104 comprises or is entirely formed of polycarbonate, defining a ⅛ inch thick polycarbonate outer tube 120 having a diameter of 2.75 inches, but the present disclosure is not limited to these dimensions. The inner tube 150 may have a ⅛ inch thick sidewall and an outer diameter of 0.75 inches, but the present disclosure is not limited to these dimensions. In one embodiment, the polycarbonate outer tube 120 and the inner tube 150 may be 5 inches long and set/seated into the respective endcaps 132 described herein at both ends with ⅛ inch deep grooves and an outer diameter of 3.25 inches.

As further shown in FIG. 3, the components of the electrical assembly 106 may include, by non-limiting example, a printed circuit board (PCB) 160 forming a circuit 161 and including a microcontroller 162, a battery 164 in operable communication with the circuit 161, at least one solar cell 166 in operable communication with the microcontroller 162 that powers the battery 164, and at least one light unit 168 such as a light emitting diode (LED) in operable communication with the microcontroller 162 and powered by the battery 164 that illuminates selectively according to the microcontroller 162 and as further described herein. Collectively, the battery 164 and the solar cell 166 form at least part of and are otherwise in electrical communication with electrical components defining a renewable charge circuit 170 devoid of moving parts to reduce biofouling.

As indicated in FIG. 3, in some embodiments, the light unit 168 includes a plurality of LED bars positioned along predetermined sides of the housing 104. The light unit 168 may further include an infrared LED, or any other light source suitable for detracting or otherwise engaging certain marine organisms. In some embodiments, the solar cell 166 includes a plurality of solar cells (e.g., thin film) wrapped along the chamber 130 of the housing 104. In some embodiments, the total surface area of these solar cells is 140 cm\hat{ }2 (two 7 cm×10 cm panels). In some embodiments, the solar cell/s 166 include high-efficiency green LEDs and the battery 164 is a rechargeable cell/s that can hold more than 500 charge cycles, and the battery 164 may be 1200 mAh. It is contemplated that variations of the configuration shown in FIG. 3 are contemplated; e.g., the BRT device may be equipped with any number of light units 168, batteries 164, solar cells 166, and the like and further electrical circuitry is also contemplated.

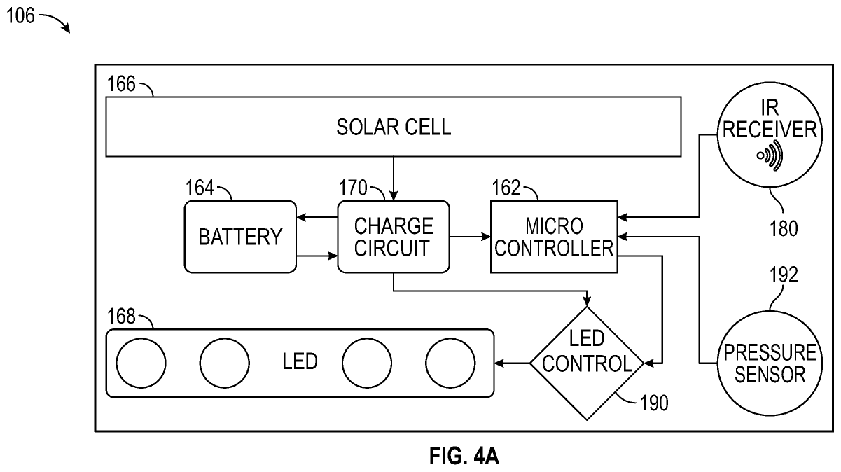

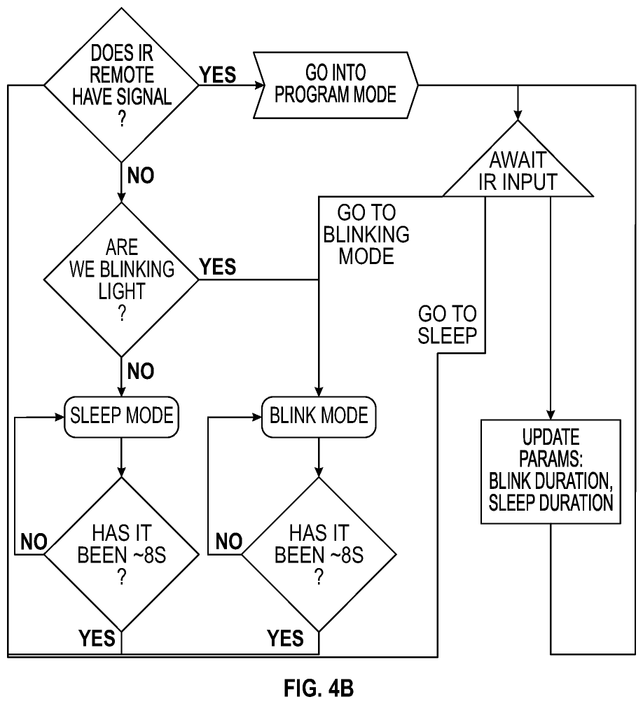

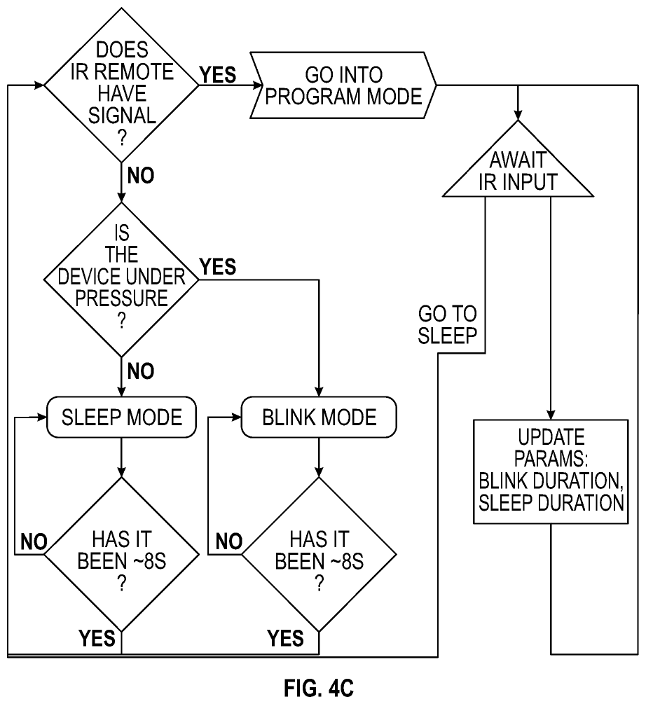

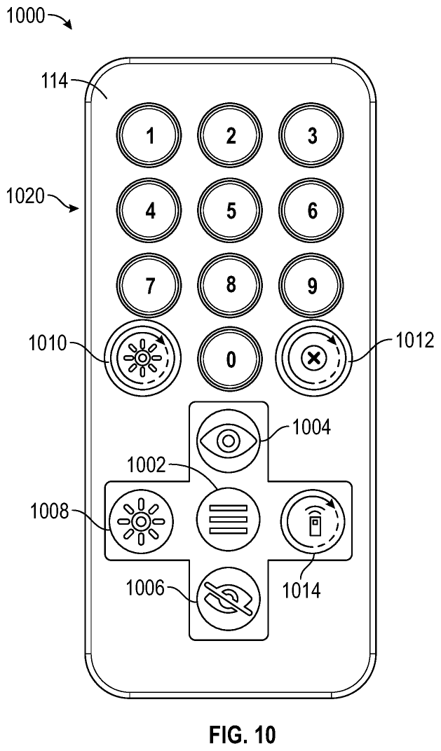

Referring to FIG. 4A, as shown, the various components of the electrical assembly 106 are integrated and operationally and electrically assembled to provide continuous use without the need to manually replace or manually charge the BRT device 102. The charge circuit 170 utilizes solar power generated by the solar cell 166 to charge the battery 164, such that the BRT device 102 does not require manual recharge or battery replacement. As indicated, the electrical assembly 106 may include a receiver 180 mounted along the PCB 101 or otherwise in electrical communication with the microcontroller 162. The receiver 180 is configured to receive and transmit data related to the operation of the BRT device 102. For example, the remote 114 may be in operable communication with the receiver 180 and the microcontroller 162, and the remote may include a plurality of input controls (shown in FIG. 10) for executing predetermined functions for illuminating the light unit 168. In some embodiments, the receiver 180 and the remote 114 are in operable communication using infrared (IR) transmission, such that the receiver 180 is an IR receiver. In one embodiment, approximately seventy two hours the BRT device 102 is assembled and ready to be deployed in the field, the BRT device 102 can be remotely programmed via the receiver 180 which may be infrared and embedded.

As part of the novel present disclosure, the microcontroller 162 is programmed or otherwise capable of executing instructions to perform any number of LED activation or modification functions for engaging and modifying aspects of the light unit 168, and/or performing predetermined charging functions (e.g., adjusting the discharge rate). In FIG. 4A, at least some of these functions are represented as LED control module 190, and encompass the logic illustrated in FIG. 4B and FIG. 4C associated with blinking or flashing functions or other functions, and responding to remote commands. More specifically, the BRT device 102 is configured to implement the light unit 168 to light flash intermittently, or selectively by the microcontroller 162. In some embodiments, a moderate flash rate similar to flash rates utilized for emergency road work and street signs can be implemented, prolonging battery life and reducing batter consumption. Adjusting the illumination or activation of the light unit 168 can be helpful for reception by marine life. For example, one specific flash rate (5 Hz (10% duty cycle); 20 ms on, 180 ms off) was used/developed for testing the BRT device 102 in the wild and reduced sea turtle bycatch by 68% in controlled fishery experiments.

In other words, by modifying or programming the LED control module 190, or otherwise providing the microcontroller 162 with executable instructions for tuning the light unit 168 and the battery 164, lighting and charging parameters may be tunable to a local environment. If the water where the BRT device 102 deployed is very turbid, the intensity of the light produced by the light unit 168 can be increased. In some embodiments, this can be accomplished by adjusting illumination settings of the light unit 168 or increasing the surface area of the solar cells 166 to increase the power harvested. In other embodiments, the duty cycle (percent of time the lights are on vs off) can be adjusted; if the light unit/s 168 are on 10% of the time they use 10% of the battery, vs. continuous illumination and 5% usage of the battery, etc. The microcontroller 162 may further be configured to vary a wavelength of light emitted by the light unit 168 according to a target ocean organism.

In some embodiments, the BRT device 102 is configured such that the light unit 168 and/or other aspects of the BRT device 102 turns on with increased pressure. Since implementations of the BRT device 102 may be deployed tens of meters below the surface of the water, pressure can be used as an indicator that they are deployed. This automates “on” and “off” configurations of the BRT device 102 without need or using a remote to minimize the programming or wireless remote use. In these embodiments, the electrical assembly 106 includes a pressure sensor 192, such as a barometric pressure sensor, attached or otherwise electrically connected to the microcontroller 162. The pressure sensor 192 may further be for utilized for flashing or blinking functionality, as described by the logic in FIG. 4C executable by the microprocessor or otherwise.

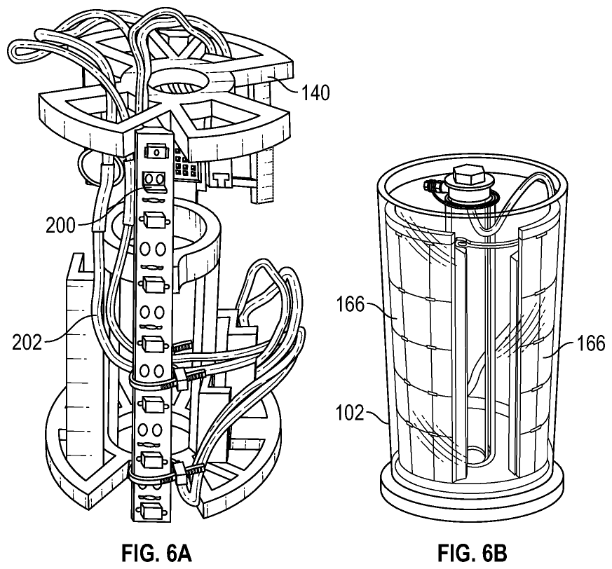

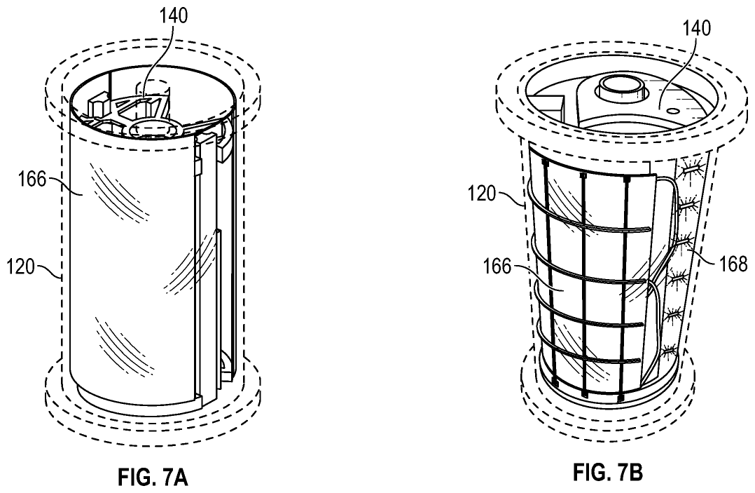

FIG. 5, FIGS. 6A-7B, and FIGS. 7A-7B illustrate different views of the BRT device 102 during various stages of assembly and emphasize the compact yet robust and strategic design of the BRT device 102. As described, optical communication with the bycatch reduction device, or preprogramming of the device, allows for the establishment of varied operational states after assembly and sealing of the device. FIG. 6A in particular indicates that the carriage 140 can include mounts or sockets 200 for the light unit 168, and that electrical connections may be established around and through portions of the carriage 140 via electrical wiring 202 or otherwise. The carriage 140 may be 3-D printed, and further embodiments of the carriage 140 and other aspects of the BRT device 102 are contemplated.

In some embodiments, the solar cells 166 of the BRT device 102 includes CdTe, CIGS, and a-Si flexible solar cells that are conformal to the inside surface of the chamber 130. One or more components of the BRT device 102 may be formed using fused-deposition modeling (FDM) and stereolithographic (SLA) printing. The housing 104 may include nylon, polyethylene, Terephthalate (PET), acrylic, polycarbonate, and/or combinations thereof. In some embodiments the endcaps 132 are formed with a disc-shaped configurations contributing to an overall cylindrical shape of the BRT device 102 that is more conducive to solar panel integration, and is more resilient to external uniform pressure (i.e., several atmospheres of pressure). The endcaps 132 may be machined from a flat piece of polycarbonate and create a shock absorbing effect and mitigate scratching of the housing 104, enhancing longevity and efficiency of the solar cells 166. In one embodiment, the BRT device 102 fully assembled is vulcanized together; that is, a predetermined solvent (by non-limiting example, dichloromethane) is used to make at least some portions of the housing 104 temporarily partially aqueous so that once the solvent has evaporated joints of the housing 104 solidify into a solid piece (e.g., joint of endcap 132A to the first end 122A of the outer tube 120).

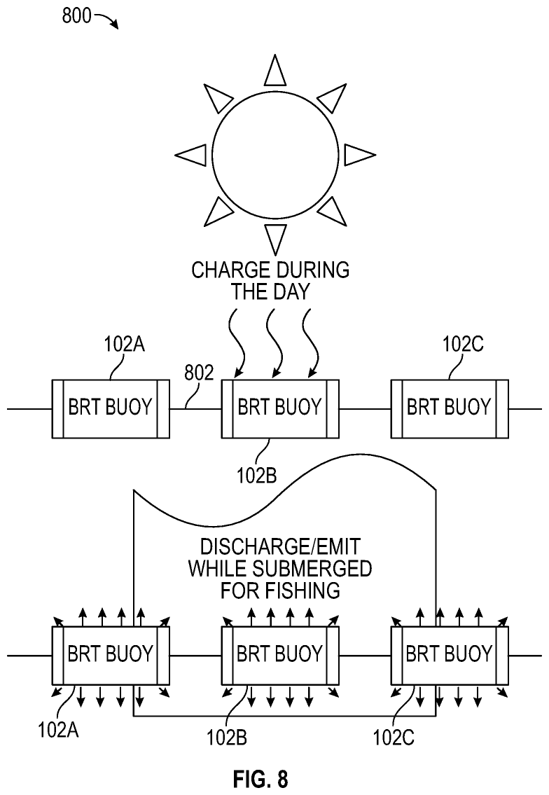

Various different implementations of the BRT device 102 are contemplated. For example, referring to FIG. 8, in one implementation 800, a plurality of the BRT devices 102A-102C may be deployed along a line 802, rope, or some elongated member. As shown, the BRT devices 102A-102C may charge during the day and emit light and may be submerged for fishing. FIG. 9 shows further possible details or additional embodiments of the implementation 800, with one or more buoys 902 (e.g., marker buoys and/or normal surface buoys) strung along the line 802 or otherwise positioned directly or indirectly along the BRT devices 102A-102C and a net 904 (e.g., gillnet or other type of net), and further including one or more weights 906 coupled to the net 904. Exemplary non-limiting dimensions and configurations are illustrated for positioning and/or spacing the BRT devices 102A-102C along the line 802 and the net 904 relative to the buoys 902.

Referring to FIG. 10, an exemplary embodiment of the remote 114 of FIG. 1 is shown. In this embodiment, the remote 114 includes a plurality of input controls 1000 which may be engaged by pressing, voice command, scrolling, swiping or any other such interactions; each corresponding to a command/mode for adjusting lighting or charging functionality of the BRT device 102. One input control 1002 may be engaged by pressing and holding the input control 1002 to enter a program mode to adjust any lighting or charging settings of the BRT device 102. Input control 1004 may be engaged to turn on a predefined blinking function so that the light unit 168 will blink or flash according to predefined settings. Input control 1006 may be engaged to turn off the light unit 168, but the light unit may 168 still be activated under the program mode as instructed by the microcontroller 162 executing any predetermined logic.

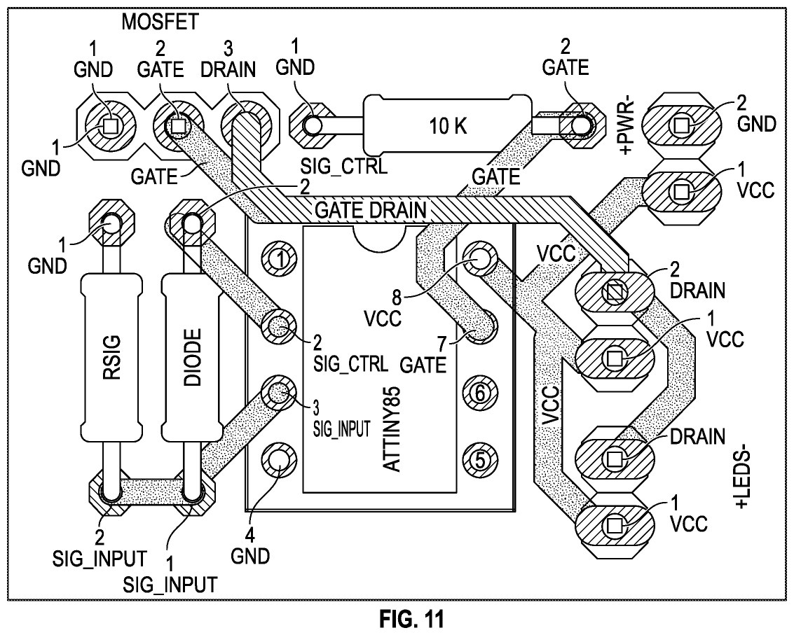

Input control 1008 may be engaged to adjust brightness of the light unit 168. Input control 1010 may be engaged to turn on the light unit 168 for a desirable duration, with default settings to 100 ms or other such value. Input control 1012 may be engaged to turn off the light unit 168 for a desirable duration, with default settings to 1 second or other such value. Input control 1014 may be engaged to enter a remote check time, with a default of eight seconds. The remote 114 may further include a numerical pad 1020 to provide numerical inputs for adjusting settings. It is contemplated that these input controls 1000 may be implemented by an app executable by a smartphone in communication with the BRT device 102 such that aspects of the BRT device 102 may be controlled by a smartphone. FIG. 11 illustrates one design for a PCB that may contain the microcontroller 162, may receive commands associated with the aforementioned input controls 1000, and may be configured for blinking, flashing, and/or temporarily engaging and disengaging lights and responding to remote commands.

Testing (Promising Results and Reception by End Users): The effects of solar-powered net illumination using flashing light (flash rate: 5 Hz (10%); duty cycle: 20 milliseconds on, 180 off) were tested by pairing illuminated nets (coupled with BRT devices 102) with control (conventional) nets. Specifically, comparisons were made between rates and proportions of target catch and bycatch biomass as well as market value and economic fishing efficiency between treatment (La illuminated) and control (La conventional) nets. Local fishers were contracted to build nets by hand with materials and specifications identical to those used by the local fleet. Both treatment and control nets used to capture turtles were 85 m long, with X cm stretched mesh and a height of X m, whereas both treatment and control nets used to capture elasmobranchs were 100 m long, with a mesh size of X cm, and a height of X m. Both net pairs were set at sunset and retrieved at sunrise, resulting in soak times of 10-14 h. The direction of the control-illuminated net pair relative to depth contours was switched after each soak, forming approximate 24 h deployments at each site.

X and Y sets of net pairs in a sea turtle and shark hotspot were deployed, respectively. The solar-powered illuminated net (with one or more BRT device 102) was matched with a control nets of the same size using 200 m rope to form an experimental net pair. Treatment nets were illuminated by solar-powered green light emitting diodes (LEDs) encased within the BRT devices 102 (used as buoys in the manner described herein) at 10 m intervals along the float line, while control nets received inactive solar-powered buoys. Nets were set over rock ledges and sandbars at depths ranging from X m to Y m to maximize catch rates of the intended bycatch or target species.

The aforementioned initial field experiments found that the solar-powered illuminated nets significantly reduced sea turtle bycatch rates, by 65 percent at night. Most importantly, these field tests showed that the flashing lights also reduced sea turtle bycatch, a necessary step for harvesting solar energy and eliminating the need to actively recharge or change the lights. Overall, fisher partners were pleased with how the lights performed. As such, these results suggest that solar-powered net illumination and the use of flashing lights represent a promising solution for mitigating sea turtle bycatch, with global applicability for passive net fisheries.

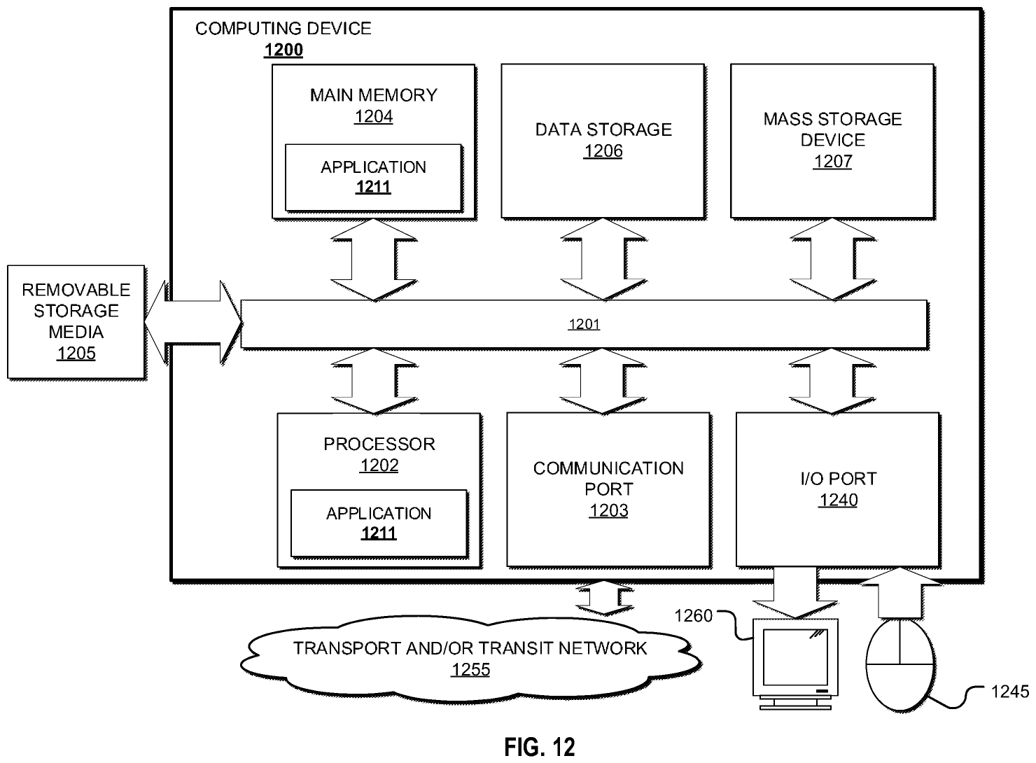

Referring to FIG. 12, a computing device 1200 is illustrated which may be associated with, deployed as, or included with the computing device 116 and be implemented to perform one or more functions described herein, via one or more of an application 1211 or computer-executable instructions. For example, aspects of the lighting and charging functions and commands described herein may be translated to software or machine-level code, which may be installed to and/or executed by the computing device 1200 such that the computing device 1200 is configured to execute functionality described herein or otherwise communicate with the BRT device 102 and/or the remote 114, and the computing device 1200 may further be implemented to display feedback or other information associated with the BRT device 102. It is contemplated that the computing device 1200 may include any number of devices, such as personal computers, smart phones, server computers, hand-held or laptop devices, tablet devices, multiprocessor systems, microprocessor-based systems, set top boxes, programmable consumer electronic devices, network PCs, minicomputers, mainframe computers, digital signal processors, state machines, logic circuitries, distributed computing environments, and the like.

The computing device 1200 may include various hardware components, such as a processor 1202, a main memory 1204 (e.g., a system memory), and a system bus 1201 that couples various components of the computing device 1200 to the processor 1202. The system bus 1201 may be any of several types of bus structures including a memory bus or memory controller, a peripheral bus, and a local bus using any of a variety of bus architectures. For example, such architectures may include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computing device 1200 may further include a variety of memory devices and computer-readable media 1207 that includes removable/non-removable media and volatile/nonvolatile media and/or tangible media, but excludes transitory propagated signals. Computer-readable media 1207 may also include computer storage media and communication media. Computer storage media includes removable/non-removable media and volatile/nonvolatile media implemented in any method or technology for storage of information, such as computer-readable instructions, data structures, program modules or other data, such as RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium that may be used to store the desired information/data and which may be accessed by the computing device 1200. Communication media includes computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. For example, communication media may include wired media such as a wired network or direct-wired connection and wireless media such as acoustic, RF, infrared, and/or other wireless media, or some combination thereof. Computer-readable media may be embodied as a computer program product, such as software stored on computer storage media.

The main memory 1204 includes computer storage media in the form of volatile/nonvolatile memory such as read only memory (ROM) and random access memory (RAM). A basic input/output system (BIOS), containing the basic routines that help to transfer information between elements within the computing device 1200 (e.g., during start-up) is typically stored in ROM. RAM typically contains data and/or program modules that are immediately accessible to and/or presently being operated on by processor 1202. Further, data storage 1206 in the form of Read-Only Memory (ROM) or otherwise may store an operating system, application programs, and other program modules and program data.

The data storage 1206 may also include other removable/non-removable, volatile/nonvolatile computer storage media. For example, the data storage 1206 may be: a hard disk drive that reads from or writes to non-removable, nonvolatile magnetic media; a magnetic disk drive that reads from or writes to a removable, nonvolatile magnetic disk; a solid state drive; and/or an optical disk drive that reads from or writes to a removable, nonvolatile optical disk such as a CD-ROM or other optical media. Other removable/non-removable, volatile/nonvolatile computer storage media may include magnetic tape cassettes, flash memory cards, digital versatile disks, digital video tape, solid state RAM, solid state ROM, and the like. The drives and their associated computer storage media provide storage of computer-readable instructions, data structures, program modules, and other data for the computing device 1200.

A user may enter commands and information through a user interface 1240 (displayed via a monitor 1260) by engaging input devices 1245 such as a tablet, electronic digitizer, a microphone, keyboard, and/or pointing device, commonly referred to as mouse, trackball or touch pad. Other input devices 1245 may include a joystick, game pad, satellite dish, scanner, or the like. Additionally, voice inputs, gesture inputs (e.g., via hands or fingers), or other natural user input methods may also be used with the appropriate input devices, such as a microphone, camera, tablet, touch pad, glove, or other sensor. These and other input devices 1245 are in operative connection to the processor 1202 and may be coupled to the system bus 1201, but may be connected by other interface and bus structures, such as a parallel port, game port or a universal serial bus (USB). The monitor 1260 or other type of display device may also be connected to the system bus 1201. The monitor 1260 may also be integrated with a touch-screen panel or the like.

The computing device 1200 may be implemented in a networked or cloud-computing environment using logical connections of a network interface 1203 to one or more remote devices, such as a remote computer. The remote computer may be a personal computer, a server, a router, a network PC, a peer device or other common network node, and typically includes many or all of the elements described above relative to the computing device 1200. The logical connection may include one or more local area networks (LAN) and one or more wide area networks (WAN), but may also include other networks. Such networking environments are commonplace in offices, enterprise-wide computer networks, intranets and the Internet.

When used in a networked or cloud-computing environment, the computing device 1200 may be connected to a public and/or private network (including, e.g., a LiFi network) through the network interface 1203. In such embodiments, a modem or other means for establishing communications over the network is connected to the system bus 1201 via the network interface 1203 or other appropriate mechanism. A wireless networking component including an interface and antenna may be coupled through a suitable device such as an access point or peer computer to a network. In a networked environment, program modules depicted relative to the computing device 1200, or portions thereof, may be stored in the remote memory storage device.

Certain embodiments are described herein as including one or more modules. Such modules are hardware-implemented, and thus include at least one tangible unit capable of performing certain operations and may be configured or arranged in a certain manner. For example, a hardware-implemented module may comprise dedicated circuitry that is permanently configured (e.g., as a special-purpose processor, such as a field-programmable gate array (FPGA) or an application-specific integrated circuit (ASIC)) to perform certain operations. A hardware-implemented module may also comprise programmable circuitry (e.g., as encompassed within a general-purpose processor or other programmable processor) that is temporarily configured by software or firmware to perform certain operations. In some example embodiments, one or more computer systems (e.g., a standalone system, a client and/or server computer system, or a peer-to-peer computer system) or one or more processors may be configured by software (e.g., an application or application portion) as a hardware-implemented module that operates to perform certain operations as described herein.

Accordingly, the term “hardware-implemented module” encompasses a tangible entity, be that an entity that is physically constructed, permanently configured (e.g., hardwired), or temporarily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure the processor 1202, for example, to constitute a particular hardware-implemented module at one instance of time and to constitute a different hardware-implemented module at a different instance of time.

Hardware-implemented modules may provide information to, and/or receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and may store the output of that operation in a memory device to which it is communicatively coupled. A further hardware-implemented module may then, at a later time, access the memory device to retrieve and process the stored output. Hardware-implemented modules may also initiate communications with input or output devices.

Computing systems or devices referenced herein may include desktop computers, laptops, tablets e-readers, personal digital assistants, smartphones, gaming devices, servers, and the like. The computing devices may access computer-readable media that include computer-readable storage media and data transmission media. In some embodiments, the computer-readable storage media are tangible storage devices that do not include a transitory propagating signal. Examples include memory such as primary memory, cache memory, and secondary memory (e.g., DVD) and other storage devices. The computer-readable storage media may have instructions recorded on them or may be encoded with computer-executable instructions or logic that implements aspects of the functionality described herein. The data transmission media may be used for transmitting data via transitory, propagating signals or carrier waves (e.g., electromagnetism) via a wired or wireless connection.

It is believed that the present disclosure and many of its attendant advantages should be understood by the foregoing description, and it should be apparent that various changes may be made in the form, construction, and arrangement of the components without departing from the disclosed subject matter or without sacrificing all of its material advantages. The form described is merely explanatory, and it is the intention of the following claims to encompass and include such changes.

It should be understood from the foregoing that, while particular embodiments have been illustrated and described, various modifications can be made thereto without departing from the spirit and scope of the invention as will be apparent to those skilled in the art. Such changes and modifications are within the scope and teachings of this invention as defined in the claims appended hereto.

What is claimed is:

1. A device for reducing bycatch, comprising:
a housing, including:
an outer tube including a first opening defined along a first end and a second opening along a second end opposite the first end, the outer tube further defining a chamber defined between the first opening and the second opening,
a first endcap positioned over the first opening of the outer tube, and a second endcap positioned over the second opening of the outer tube to enclose the chamber; and
an electrical assembly positioned within the chamber of the housing, including:
a circuit including a microcontroller,
a battery in operable communication with the circuit,
a solar cell in operable communication with the microcontroller that charges the battery, and
a light emitting diode in operable communication with the microcontroller and powered by the battery that illuminates selectively according to the microcontroller.

2. The device of claim 1, wherein the battery is rechargeable, and the solar cell and the battery collectively form an internal self-powering and renewable charge circuit devoid of moving parts to reduce biofouling.

3. The device of claim 1, wherein the light emitting diode (LED) includes a plurality of LED bars positioned along different predetermined sides of the housing.

4. The device of claim 1, wherein the microcontroller is configured to vary a wavelength of light emitted by the light emitting diode according to a target ocean organism.

5. The device of claim 1, wherein the microcontroller is configured to execute a blinking mode such that the light emitting diode blinks for a predetermined time period and minimizes energy consumption from the battery.

6. The device of claim 1, wherein the solar cell includes a plurality of solar cells wrapped along the chamber of the housing.

7. The device of claim 1, wherein the housing is formed of a polycarbonate material and is at least partially transparent to accommodate illumination by the light emitting diode through the housing.

8. The device of claim 1, further comprising:
a receiver positioned along the housing and in operable communication with the microcontroller; and
a remote in operative communication with the receiver and the microcontroller, the remote including a plurality of input controls for executing predetermined functions for illuminating the light emitting diode.

9. The device of claim 1, wherein the housing is formed with a cylindrical shape configuration resembling a buoy and is mechanically coupled to a net.

10. The device of claim 1, wherein the first endcap and the second endcap are sealed along the first opening and the second opening respectively to form a permanent waterproof seal.
